(19) United States
(12) Patent Application Publication
(10) Pub. No.: US 2009/0218811 A1
(43) Pub. Date: Sep. 3, 2009

(54) Adhesively Secured, Fluid-Tight Pipe Joint Of PVC/CPVC Pipe And Fitting

(75) Inventors: Robert M. Frimel, Vermillion, OH (US); Andrew M. Olah, Spencer, OH (US); Girish T. Dalal, Avon Lake, OH (US)

Correspondence Address: LEGAL DEPARTMENT;LUBRIZOL ADVANCED MATERIALS, INC, 9911 BRECKSVILLE ROAD, CLEVELAND, OH, 44141-3247, US

(73) Assignee: LUBRIZOL ADVANCED MATERIALS, INC., Cleveland, OH (US)

(21) Appl. No.: 12/394,105

(22) Filed: Feb. 27, 2009

Related U.S. Application Data
(60) Provisional application No. 61/032,242, filed on Feb. 28, 2008.

(51) Int. Cl. F16L 13/00; B32B 37/14

(52) U.S. Cl. 285/285.1; 156/294

(57) ABSTRACT

PVC and/or CPVC tubing and/or pipe is adhesively-secured at one end with a pipe fitting telescopably mated with each other with a uniquely effective epoxy adhesive. The resulting pipe joint is fluid-tight. PVC pipe joints meet the requirements of ASTM F1970; CPVC pipe joints meet the requirements of ASTM D2864. Such PVC and CPVC piping systems are chosen to carry cold and hot aqueous streams respectively, under pressure and elevated temperature in continuous service, both, in industrial and domestic piping systems. Such piping systems also carry more corrosive fluids for specified duration, less than 50 years.

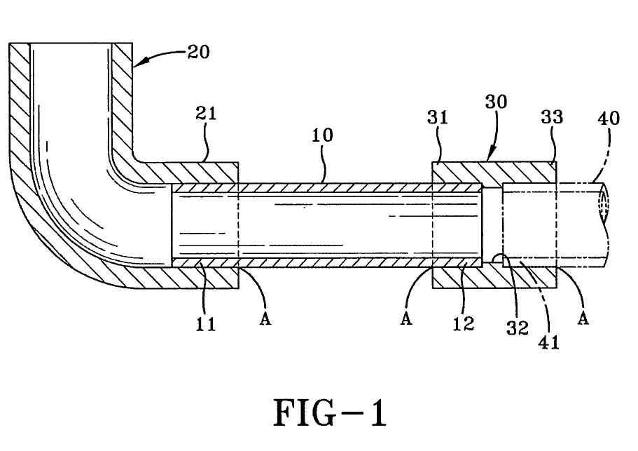

### RELATED U.S. APPLICATION DATA

This application claims priority from U.S. Provisional Application Ser. No. 61/032,242 filed on Feb. 28, 2008.

### FIELD OF THE INVENTION

This invention relates to an adhesively secured pipe joint in a piping system in which pipe, made by extruding either a poly(vinyl chloride) (“PVC”) or post-chlorinated poly(vinyl chloride) (“CPVC”) compound, is fitted at its ends with a pipe fitting made of either PVC or CPVC (hereafter referred to as “PVC/CPVC”) respectively, to provide a fluid-tight pipe joint.

### BACKGROUND OF THE INVENTION

The physical properties of “PVC/CPVC” pipe are widely extolled and deservedly so. Reference herein to PVC and to CPVC pipe and pipe fittings includes those made from copolymers containing a predominantly large amount of vinyl chloride monomer and less than 10% by weight of another comonomer, because the properties of such copolymers with little comonomer, are essentially indistinguishable from those of PVC homopolymer, or CPVC derived from the PVC homopolymer. These properties include (a) a high distortion temperature under load (DTUL), also referred to as heat distortion (or deflection) temperature (HDT), that for CPVC being higher than that for PVC; (b) ductility at a relatively low temperature which allows the pipe to be extruded with a low risk of burning the pipe; (c) poor flammability, resulting in their use in flame retardant piping systems; and, (d) for CPVC pipe, a high resistance to rupture (high hoop strength) at much higher temperature than that for PVC, e.g., when carrying water at 82.2° C. (180° F.) under 790 KPa (100 psi, pounds per square inch gauge) pressure.

Combined with the excellent corrosion resistance of PVC/CPVC pipe and fittings, such properties decreed that cylindrical pipe with inner and outer smooth circumferential surfaces be commercially produced by several resin manufacturers. The pipe is to be assembled to form a pipe joint (referred to herein for brevity as a “joint”), without any mechanical interlocking of the pipe and fitting, whether such mechanical interlocking entails mechanical fittings, threads cut into the pipe, grooves with O-rings in them, indentations or interlocking grooves formed longitudinally in an end of a pipe. The fitting to be used to form the novel joint is a standard fitting, which is commonly used in a PVC/CPVC piping system which meets ASTM specifications. Such a fitting has a barrel portion adapted to be telescopably mated to the pipe. Conventional fittings include a cap, an ell, street ell, or tee, each having at least one socket or barrel appropriately dimensioned to mate with an end of pipe to which the fitting is to be mated.

PVC conduit, whether tubing or pipe, is made in a wide range of sizes most commonly having a diameter in the range from 12.7 mm (0.5 inch) to 15.24 cm (6 ins). Conduit with a diameter smaller than 19.05 mm (0.75″) nominal diameter is typically referred to as “tubing”, even if rigid; conduit with a diameter larger than 19.05 mm (0.75″) nominal diameter is typically referred to as “pipe”, which is rigid. For convenience and brevity, PVC conduit of arbitrary diameter is referred to herein as “pipe” as long as it lends itself to having a fitting secured to its end, whether by being mated to the outer surface of the pipe, or to the pipe's inner surface.

CPVC conduit, like PVC pipe, is also made in a wide range of sizes; all are referred to as “pipe” which is rigid in diameters larger than 19.05 mm (0.75″) unless formulated for an end use which requires that the pipe be bent, for example, in “in-the-floor” fluid-heating systems, when thin-walled CPVC pipe is extruded from a compound which allows the pipe to be bent 180° provided the radius of the bend is at least six (6) times the nominal diameter of the pipe.

Both PVC and CPVC pipe are extruded from compounds formulated with a wide array, and widely divergent amounts, of fillers, pigments, stabilizers, lubricants, antioxidants, glass transition (Tg) enhancing additives, and other ingredients, each pipe being formulated with different combinations and amounts of ingredients, depending upon the particular environment is which the pipe will be used. The amount and type of plasticizer used in PVC compounds depends upon the flexibility desired in the pipe.

PVC pipe is widely used in cold water and other aqueous distribution systems in both industrial and domestic installations where continuous service under these conditions is demanded. CPVC pipe is also widely used, but particularly in hot water systems operating at as high as 82.2° C. (180° F.). By “continuous service” is meant that the pipe is subjected to the specified operating conditions without interruption over a period of 50 years.

Reference to a “PVC/CPVC piping system” herein, is to a system which is assembled with pipe and fittings either of PVC or CPVC. A PVC piping system is required to meet ASTM standards different from those a CPVC piping system is to meet. An adhesive used to secure pipe to a fitting, whether in a PVC or a CPVC piping system, must provide a joint which will meet ASTM requirements.

The drawback of a conventional PVC/CPVC piping system is that the pipe joints are required to be solvent-cemented with a solvent-based cement in which the solvent is deemed to be toxic to humans if ingested at relatively low levels. An end of pipe to which a fitting is to be mated, and the fitting are each coated on its mating surface with the solvent-based cement just before they are assembled, and then the pipe and fitting are mated so as to squeeze out excess cement from between the mating surfaces. The solvent is required to substantially evaporate before the joint is deemed “finished” and ready for use. A very small amount of solvent remains trapped between the mating surfaces for a short period which may be as long as 3 days, depending upon ambient conditions. If the piping system is put into operation prior to the evaporation of all the solvent, there is a chance that some of the solvent will be carried in the fluid being piped in the system. When that fluid is potable water, the risk of having solvent contaminate the water is minimized if not negated, by using an adhesive in which there is no solvent to be evaporated.

Another problem presented by using a solvent cement to solvent weld pipe joints is the giving off of volatile organic compounds (VOCs), as a result of the solvent evaporating from the cement. VOCs are thought to be harmful to the environment and are being increasingly curtailed by government regulations. A pipe joining adhesive that does not give off VOCs would be highly desirable.

Though leakage of fluid carried by a piping system typically occurs from within the pipe to the outside (e.g., water, HCl acid, or H₂SO₄ acid) resulting in loss of the fluid, leakage may also occur from outside the pipe into it, (e.g., ground water penetration in buried pipe carrying electrical cable) to destroy the cable protected by the pipe. To date, numerous efforts have been made to adhesively secure a PVC/CPVC fitting at the end of a PVC/CPVC pipe without having the joint leak under normal operating conditions, but there is no record of anyone having provided a satisfactorily fluid-tight PVC/CPVC pipe joint which meets the required ASTM standards.

In the past, there has been confusion between solvent-cementing a joint and adhesively securing it. A solvent-cemented joint may be solvent-welded, but it is not adhesively-secured. The mechanism for solvent cementing a joint requires dissolving polymer at the mating surfaces so that the cement secures the joint after the solvent is evaporated. There is no dissolution of polymer at the mating surfaces in an adhesively-secured joint.

Adhesively securing one surface of a synthetic resin (“polymer”) to a surface of the same or another polymer to provide a fluid-tight joint, is generally a difficult problem, irrespective of the polymers involved, due to the low surface energy of polymers. Adhesively securing a PVC or CPVC surface to another PVC or CPVC surface, respectively, is a far more difficult problem because the chlorinated polymers have lower surface energy than common non-chlorinated synthetic resins. Identifying any adhesive which will provide a fluid-tight joint has been routinely glossed over in the prior art with the naive expectation that the difficulty of providing such an adhesive will likely be lost on one not intimately familiar with the problem. Finding and specifying a polymeric adhesive containing essentially no solvent to be evaporated, was clearly a particularly difficult problem.

The degree to which the difficulty of adhesively securing PVC or CPVC surfaces was misjudged, is evidenced by a disclosure of Wilhelmsen in U.S. Pat. No. 3,826,521 stating he provided a simple means for repairing a ruptured, rigid PVC pipe the end of which was fitted with “a conventional coupling and securely sealed by an approved adhesive in the usual manner”. (see col. 2, lines 8-11). Over the supervening three decades, epoxy, urethane and cyanoacrylate adhesives have been disclosed in expansive generality in numerous publications without specifically identifying a satisfactory adhesive which will meet die requirements of ASTM F1970 for PVC and ASTM D2846 for CPVC. Such generalities serve only to focus the difficulty of finding and identifying an adhesive, approved or not, which difficulty has continued to loom large.

### The Problem:

Trace amounts of residual solvent in a solvent-based cement, small as they may be, and irrespective of when they might occur, incite grave concern among those who use such piping systems to carry potable water. Though most PVC/CPVC fittings for PVC/CPVC pipe currently sold and assembled in solvent-cemented pipe joints, are never troubled with the problem of trace quantities of residual solvent, it is deemed nevertheless desirable to avoid using any solvent, or so little that its presence is undetectable. To date, no adhesive has been found which satisfactorily secures a PVC/CPVC pipe fitting to PVC/CPVC pipe to form a joint which is both fluid-tight so as to meet the requirements of ASTM F1970 for PVC, and ASTM D2846 for CPVC and which also provides continuous service.

### The Solution:

By dint of laborious trial and error, involving continuous experimentation over several years, the accumulated data from tests presented below indicated an unexpectedly effective adhesive bond resulting from the use of a particular epoxide adhesive comprising a known epoxy resin and curing liquid(s) therefor, together referred to herein as “epoxy”. This epoxy is an adhesive commercially available from Henkel/Loctite under the designation E-120HP and is believed to be an elastomer modified epoxy resin cured with a polyamide/polyamine blend. This epoxy is preferably modified to contain a coloring agent such as an inert filler or dye; or, a fluorescing agent; or, a viscosity-modifying agent; the choice of the type and amount of each of which agents to perform its desired function, is well known to those skilled in the art. Each, whether coloring agent, or fluorescing agent or viscosity-modifying agent, is chemically unreactive with the other components of the adhesive. The dye may be chosen either to match the color of the PVC/CPVC pipe and pipe fitting, or to contrast the color of the pipe joint to provide visual confirmation that the adhesive has been substantially uniformly applied to form the joint. The fluorescing agent may be chosen to fluoresce when exposed to ultraviolet light in a wavelength referred to as “black light”.

The resin and curing liquid are mixed immediately prior to being coated onto the respective mating surfaces of an end of the pipe, and of the pipe fitting, and then the pipe and fitting are assembled.

### SUMMARY OF THE INVENTION

A particular epoxide adhesive, when spread on PVC/CPVC mating surfaces prior to their being assembled, is found to avoid solvent-cementing the surfaces and yet provide a fluid-tight joint after a controllable time over which the epoxy is cured. The cured PVC/CPVC joint has tensile, compressive and torsional strength which result in a pressure rating exceeding that required by the appropriate ASTM standard, namely, ASTM F1970 for PVC, and ASTM D2846 for CPVC. Unless deliberately colored, or caused to fluoresce, the cured joint visually appears no different from one which is conventionally solvent-cemented (or “solvent-welded”) with a solvent-based cement, but the adhesively-secured joint has the advantage of not using a solvent deemed toxic if ingested and not giving off VOCs.

Using the epoxy avoids solvent-cementing the pipe joint and the concomitant evaporation of solvent. In addition, unlike a freshly solvent-cemented joint which “sets” within a minute or so, negating relative movement between components of the joint in the event that minute last-minute adjustments in orientation of the components, or the length of an assembly becomes necessary, a pipe joint adhesively-secured with the epoxy used herein allows from 5 mins.-1 hr. or more, depending upon the temperature at which the joint is made. Such minor adjustments in orientation, after assembly, are possible because the epoxy cures more slowly than solvent-cement sets.

A pipe joint is provided which is free of any mechanical interlocking means between the pipe and a fitting to be fitted at an end of the pipe. The joint comprises, a poly(vinyl chloride) (“PVC”) or chlorinated poly(vinyl chloride) (“CPVC”) pipe having a circular cross-section with inner and outer diameters at each end, and smoothly circumferential inner and outer surfaces free of grooves, threads or indentations. The pipe fitting has a smoothly circumferential mating surface free of grooves, threads or indentations, adapted to be matingly telescopably received at an end of the pipe. A fitting may be fitted over the end of the pipe, so that the outer surface of the pipe is adhesively-secured to the inner surface of the fitting; or, a fitting may be fitted inside the end of a pipe, so that the inner surface of the pipe is adhesively-secured to the outer surface of the fitting.

A two-part adhesive composition comprising the aforespecified epoxy resin and blend of polyamide/polyamine curing agent or hardener is spread across adjacent mating surfaces of the pipe and pipe fitting prior to being mated. The hardener having a viscosity in the range from about 2,000 to 6,000 cps at 25° C. (77° F.), is thoroughly mixed with the epoxy resin, most preferably in a 2:1 ratio, which provides an “in-service”-temperature curable adhesive composition when it is spread across the mating surface of the pipe and the mating surface of the pipe fitting prior to being mated. The adhesive is also believed to include silica, and optionally, a die or fluorescing agent, and also a viscosity-modifying agent, each of which components are known to those skilled in the art, chosen so as to provide a cured epoxy within from 5 min. to 1 hr. after application at an in-service temperature in the range from 15° C.-29.4° C. (47° F.-85° F.). Upon the epoxy adhesive being cured, the joint meets the requirements of ASTM F1970 for PVC, and ASTM D2846 for CPVC.

Though the foregoing two-part adhesive is described herein to adhesively secure components of a PVC/CPVC pipe joint, one skilled in the art will readily appreciate that the adhesive is equally well-suited to adhesively secure any PVC/CPVC mating surfaces, irrespective of the surface configuration of each mating surface, as long as the surfaces are in close contact, and the interstitial space between mating surfaces is sufficient to allow the adhesive to penetrate that space. In a piping system, the annular circumferential interstice between mated pipe and fitting defines that space.

### BRIEF DESCRIPTION OF THE DRAWING

The foregoing invention will best be understood by reference to the following detailed description of particular fittings representative of those to be used to make a leak-proof connection between a pipe fitting and an end of PVC/CPVC pipe, accompanied with a schematic illustrations in which:

The FIGURE is a side elevational view, in longitudinal cross-section, of a first pipe joint in which a PVC/CPVC pipe has one end matingly inserted into one socket of a conventional right elbow or “ell”; and, forming a second pipe joint, the other end of the first pipe is inserted in a first socket of a conventional coupling having cylindrical sockets; and, forming a third pipe joint, one end of a second PVC/CPVC pipe is inserted into the second, opposed socket of the coupling; and, each fluid-tight pipe joint includes cured epoxy disposed substantially uniformly between mating surfaces of each joint.

### DETAILED DESCRIPTION OF PREFERRED EMBODIMENTS

Reference to PVC/CPVC pipe and pipe fittings herein reference to pipe which may be extruded from one or the other compound, and mated to a pipe joint formed from one or the other compound, respectively. In other words, PVC pipe is matched with PVC pipe fittings, and CPVC pipe is matched with CPVC pipe fittings.

The PVC and CPVC compounds used to make the pipe and fitting used in this invention are those which preferably have a majority (over 50% by weight) of the polymer components of the compound being PVC resin or CPVC resin, preferably at least 80% by weight. The PVC and CPVC compounds will typically contain other ingredients such as stabilizers, lubricants, fillers, colorants, and the like.

### The PVC Pipe and Fittings for the Pipe:

PVC pipe and pipe fittings are commodities widely distributed by manufacturers around the globe. PVC, either in pellets or as powder, is extruded to form pipe, or is injection-molded or otherwise thermoformed, to form a pipe fitting. The PVC is derived from polymer having an inherent viscosity (I.V.) in the range of 0.50 to 1.6, preferably from 0.52 to 1.0; a fused density of about 1.35 g/cc and a Cl content of about 56.7%. The PVC resin may be fonned by mass, suspension or emulsion polymerization techniques. Examples of suitable PVC resins include Geon 103EPF76TR, 103 EPF76, 30, 110X440, 27 and 1023PF5 PVC; Geon M6215 and M6230 rigid injection molding PVC; Geon 85890 and 85891 cellular injection molding PVC; Geon 8700A, 8700x, 87256, and 87160 interior rigid extrusion PVC; Geon 87416, 87703 and 6935 exterior rigid extrusion PVC; and Geon 85893, 87344, 87345, 87538, 87695 and 87755 rigid powder extrusion PVC. The PVC resins are all available from Oxy Vinyls and the PVC compounds are available from PolyOne.Copolymers of PVC are formed with vinyl chloride monomer being present in a major amount by weight, typically in excess of 80%, the other monomer being present in 20% or less. A commonly produced pipe uses vinyl acetate as comonomer, and the pipe produced has a polymer surface which is as compatible with the epoxy found effective in the novel pipe joint, as a surface of PVC homopolymer. Less commercially significant copolymers are disclosed in Volume 1 of Encyclopedia of PVC, edited by Leonard I. Nass, Marcel Dekker, Inc. (N.Y. 1976, Chap. 4). Preferably, a homopolymer of PVC is used.

### The CPVC Pipe and Fittings for the Pipe:

CPVC, whether for pipe or for fittings, is most commonly made by post-chlorination of PVC homopolymer, and less commonly by post-chlorination of a PVC copolymer such as one described hereinabove. The process for making CPVC from PVC for CPVC pipe is well known in the art, as are compounds specifically formulated for particular uses. These are described in U.S. Pat. Nos. 2,996,049; 3,100,762; 5,194; and 5,591,497 inter alia, the disclosures of which are incorporated by reference thereto as if fully set forth herein. Most preferred is CPVC having a Cl content in the range from 65%-70%, which CPVC is derived from PVC having an inherent viscosity (I.V.) measured as stated in ASTM D1243 in the range from 0.5 to about 1.6, preferably from 0.80 to 1.0.

The following commercially available adhesives, deemed most likely to be effective adhesives, were tested with CPVC CTS pipe, in a Long Term Hydrostatic test (a) over 1000 hr. at 65.5° C. (150° F.) and 2.65 MPa (370 psig); and (b) over 1000 hr. at 82.2° C. (180° F.) for CPVC pipe, as required by ASTM D2846. Each adhesive was prepared for use as recommended by the manufacturer. A designation of “passed” indicates that the adhesive passed all requirements; a designation of “failed” indicates that the joint leaked.

| Adhesive | Pass/Fail |
|---|---|
| Loctite ® Hysol ® E-90FL | Failed |
| Loctite ® Hysol ® E-20HP | Failed |
| Loctite ® Hysol ® E-120HP | Passed |
| Loctite ® Hysol ® U-05FL | Failed |
| Loctite ® Depend ® H3001 | Failed |
| Henkel/Loctite ® H3000 | Failed |
| Henkel/Loctite ® E-120HP | Passed |

In an analogous manner, each of the following commercially available adhesives, deemed most likely to be effective adhesives, were tested with PVC IPS pipe, in a Long Term Hydrostatic test (a) over 1000 hr. at 3.2 MPa (450 psi) and 22.7° C. (73° F.) for PVC pipe, as required by ASTM F1970.

The results of the foregoing required test for PVC pipe are as follows:

| Adhesive | Pass/Fail |
|---|---|
| Loctite ® Hysol ® E-90FL | Failed |
| Loctite ® Hysol ® E-20HP | Failed |
| Loctite ® Hysol ® E-120HP | Passed |
| Loctite ® Hysol ® U-05FL | Failed |
| Loctite ® Depend ® H3001 | Failed |
| Henkel/Loctite ® H3000 | Failed |
| Henkel/Loctite ® E-120HP | Passed |

Each adhesive was tested (ASTM F1970 for PVC and ASTM D2846 for CPVC) in pipe joints such as are shown in the FIGURE, wherein, for illustration, there is shown three pipe joints of matched CPVC pipe and standard CTS (copper tube standard) or IPS (iron pipe standard) CPVC pipe fittings on the mating surfaces of which the epoxy adhesive “A” is uniformly coated prior to assembly of the pipe joints. When the coated surfaces are telescopably mated, excess adhesive from between the mating surfaces is pushed outward and forms a bead. The bead fills the circumferential line where the rim of the socket of a fitting lies snugly against the outer circumferential surface of the end of the pipe.

The tests with the adhesives listed above indicate that the only adhesives which passed were those with the E-120HP designation. Both adhesives which passed are believed to be substantially similar in composition, and believed to hew to the description provided above. The adhesive is a two-part adhesive both of which parts are mixed just prior to being applied to a surface of the joint. A first part is a fluid elastomer modified epoxy resin, and the second part is a fluid combination of a polyamide and a polyamine, one or both parts containing an inert filler believed to be silica. For in-service application, each part is conveniently packaged in a tubular dispenser and the contents of each dispenser are mixed just prior to application. Each epoxy resin has a pasty consistency too thick to be measured with a conventional viscometer; the hardener for the E-120HP is relatively fluid having a viscosity of 3000 cp at room temperature (@25° C. (77° F.).

If it is desired to have a visual confirmation that the adhesive has been uniformly distributed between the mating surfaces of the pipe joint, the adhesive may be colored either to contrast or match the color of the PVC/CPVC pipe. Off-white pipe is extruded using compound containing an inert filler which is typically titania or silica; black pipe is typically made from compound containing carbon black.

The adhesive may also contain a fluorescent dye which fluoresces in ultraviolet light.

For ambient in-service temperatures in the range from 10° C.-35° C. (50° F.-95° F.), the viscosity of the epoxy resin, after it is homogeneously mixed with hardener, in a 1:2 ratio, both as commercially available, and measured with a Brookfield RVT Viscometer with Small Sample Sample Adapter (SSA) and #14 spindle, is as follows:
@10° C. (50° F.):

| 1 rpm | 200,000 cps |
|---|---|
| 10 rpm | 116,000 cps |
| T.I.* | 1.72 |

*Thixotropic Index = (Viscosity @ 1 rpm/Viscosity @ 10 rpm)

@25° C. (77° F.):

| 1 rpm | 140,000 cps |
|---|---|
| 10 rpm | 66,000 cps |
| T.I. | 2.12 |

@35° C. (95° F.):

| 1 rpm | 108,000 cps |
|---|---|
| 10 rpm | 40,000 cps |
| T.I. | 2.70 |

At in-service temperatures in the ranges given above, it is evident that the viscosity of the mixed adhesive is low enough to allow it to be spread uniformly as a thin layer over the surfaces to be joined, so that a small amount of excess adhesive is forced out of the sealing line of the joint, allowing the epoxy to cure around the periphery of the joint before the adhesive in the interstitial space between the mating surfaces is cured.

For use at an in-service temperature either below or above the aforementioned range, it is desirable to control the viscosity of the adhesive when its resin and curing components are mixed, and to do so, one or both components may include a viscosity modifier, known in the art, to tailor the viscosity for a desirable viscosity.

A desirable viscosity of the adhesive, at a chosen in-service temperature, is such that the mixture of epoxy resin and curing agent, optionally with a viscosity-modifier, is usably fluid and will cure in the temperature range −10° C. (14° F.) to 40° C. (104° F.) at which the adhesive may be used.

By “usably fluid” is meant that the mixture is fluid enough to be readily spread over each surface to be adhesively-secured, particularly when one is telescopably inserted into another and rotated in the range from 45° to 135°.

It may be desirable to provide several modifications of the epoxy resin and curing agent, each formulated for a chosen narrow in-service-temperature range. Each epoxy and hardener is formulated so as to result, when mixed, in an adhesive with a viscosity desirable for that temperature range, and so as to have a more reliably predictable curing time than a single epoxy resin formulated so as to provide an acceptable viscosity throughout a broad in-service temperature range from about 10° C. to 35° C. (50° F.-95° F.), but which cures over a wide range of curing periods.

For example, a “low temperature range epoxy” may be formulated with an epoxy resin and curing agents to provide the desirable viscosity and which will cure in from 5 min. to 1 hr., at a temperature in the range from −10° C. to 15° C. (14° F.-59° F.); a “medium temperature range epoxy” may be formulated with an epoxy resin and curing agents to provide the desirable viscosity and which will cure in from 5 min. to 1 hr., at a temperature in the range from 15° C.-30° C. (59° F.-86° F.); and, a “high temperature range epoxy” may be formulated with an epoxy resin and curing agents to provide the desirable viscosity and which will cure in from 5 min. to 1 hr., at a temperature in the range from 30° C.-40° C. (86° F.-104° F.).

Referring to the FIGURE, in a first pipe joint, a first length of CPVC pipe 10 has one end, referred to as a left band end 11, matingly inserted in one end, referred to as a lower socket 21 of a right-ell 20 until the rim of the left hand end 11 is inserted into socket 21 over a length ranging from 0.5 times the nominal diameter of pipe 10, to a length equivalent to the nominal diameter, so as to ensure a secure fluid-tight joint when adhesive A is cured.

In a second pipe joint, the other end of pipe 10, referred to as a right hand end 12, is matingly inserted in left hand socket 31 of a CPVC coupling 30, until the rim of the end 12 abuts a circumferential shoulder 32 which projects radially inwards from the otherwise smooth circumferential area of the inner surface of the coupling, for a short distance sufficient to obstruct passage of the rim 12 past the mid-point of the length of the coupling 30. When adhesive A is cured, the pipe joint is fluid-tight.

In a third pipe joint, a second CPVC pipe 40, a portion of which is shown in phantom outline, has a left end 41 matingly inserted in right hand socket 33 of the coupling 30, in mirror-image relationship with right hand end 12 of first pipe 10, and left end 41 abuts the circumferential shoulder 32. When adhesive A is cured, the pipe joint is fluid-tight.

Having thus provided a general discussion of the novel pipe joint, described it in detail, and illustrated the pipe joint with specific illustrations of the best mode known to the inventors of making and using the joint, it will be evident that the novel pipe joint has provided an effective solution to an old, unresolved problem. It is therefore to be understood that no undue restrictions are to be imposed by reason of the specific embodiments illustrated and discussed, and particularly that the novel pipe joint is not restricted to a slavish adherence to the details set forth herein.

What is claimed is:

1. A pipe joint free of any mechanical interlocking means between the pipe and a fitting to be fitted at an end of the pipe, the joint comprising:
a poly(vinyl chloride) (“PVC”) or chlorinated poly(vinyl chloride) (“CPVC”) pipe having a circular cross-section with inner and outer diameters at each end, and a smoothly circumferential inner surface free of grooves, threads or indentations;
a PVC or CPVC pipe fitting having a smoothly circumferential mating surface free of grooves, threads or indentations, adapted to be matingly received at an end of the pipe; and
a room temperature curable adhesive composition spread across the mating surface of the pipe and the mating surface of the pipe fitting prior to being mated, the adhesive comprising a mixture of an elastomer modified epoxy resin, and a curing agent or hardener comprising a blend of a polyamide and a polyamine, wherein the adhesive has a desirable viscosity at a chosen in-service temperature;
whereby upon curing, the joint meets the requirements of ASTM F1970 for PVC, and ASTM D2846 for CPVC.

2. The pipe joint of claim 1 wherein the adhesive includes a known additive selected from the group consisting of silica, a fluorescing agent, a coloring agent to match or contrast the joint's color, and a viscosity-modifying agent.

3. The pipe joint of claim 1 wherein the pipe is extruded from a PVC compound and the fitting is thermoformed from a PVC compound.

3. The pipe joint of claim 1 wherein the pipe is extruded from a CPVC compound and the fitting is thermoformed from a CPVC compound.

4. The pipe joint of claim 2 wherein:
the hardener has a viscosity in the range from about 2,000 to 6,000 cps at 25° C. (77° F.); and
the adhesive has a desirable viscosity at a chosen in-service temperature in the range from about −10° C. (14° F.) to 40° C. (104° F.);
whereby the pipe and pipe fitting, when telescopably inserted one into the other, are rotatable relative to one another in the range from 45° to 135°.

5. The pipe joint of claim 4 wherein the chosen in-service temperature is in the range from 10° C. (50° F.) to 35° C. (95° F.) and the desirable viscosity is in the range from about 200,000 cps to about 40,000 cps.

6. A method for joining a poly(vinyl chloride) (“PVC”) or chlorinated poly(vinyl chloride) (“CPVC”) pipe to a PVC or CPVC pipe fitting comprising:
(a) applying a room temperature curable adhesive composition spread across the mating surface of said pipe and said pipe fitting;
(b) inserting said pipe into said pipe fitting;
(c) rotating said pipe and said pipe fitting relative to one another in the range of from 45° to 135°;
(d) curing said adhesive for 5 minutes to 1 hour at a temperature in the range from 15° C. to 29.4° C. (47° F. to 85° F.);
wherein said adhesive comprises a mixture of an elastomer modified epoxy resin and a curing agent or hardener comprising a blend of a polyamide and a polyamine; and wherein upon curing, the joined pipe and fitting meets the requirements of ASTM F1970 for PVC or ASTM D2846 for CPVC.
